(19) United States
(12) Patent Application Publication
(10) Pub. No.: US 2005/0034174 A1
(43) Pub. Date: Feb. 10, 2005

(54) Digital receiving device and digital broadcasting receiving method

(75) Inventor: Shinichi Hatanaka, Kumagaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/912,777

(22) Filed: Aug. 5, 2004

(30) Foreign Application Priority Data
Aug. 8, 2003 (JP) 2003-290453

(51) Int. Cl. H04N 7/16

(52) U.S. Cl. 725/151; 725/139

(57) ABSTRACT

A tuner varies a reception frequency to receive each channel of a digital broadcasting signal at a standby time. A separation section separates network information table (NIT) information from a transport stream of each channel. A system control section and a memory take and store service identification information including area information included in NIT. First service identification information stored already in the memory is compared with new second service identification information corresponding to the first identification information to judge whether or not there is a change, and a change content is displayed, when there is the change.

### CROSS-REFERENCE TO RELATED APPLICATIONS

This application is based upon and claims the benefit of priority from prior Japanese Patent Application No. 2003-290453, filed Aug. 8, 2003, the entire contents of which are incorporated herein by reference.

### BACKGROUND OF THE INVENTION

1. Field of the Invention

The present invention relates to a digital receiving device and a digital broadcasting receiving method in which a method of acquiring a service list is improved, and is useful as a device which receives terrestrial digital broadcasting.

2. Description of the Related Art

In terrestrial digital broadcasting which has been developed in recent years, a packet including a network information table (hereinafter referred to as NIT) is included in a transport stream (hereinafter referred to as TS). The NIT includes various types of information necessary for receiving a program. The NIT includes a remote controller key id. The remote controller key id is used to allocate a key number of a remote controller for selecting a program. For example, when the remote controller key id sent by a certain TS is “1”, the key number “1” of the remote controller is associated as a key number for receiving a representative program in the transport stream corresponding to the key id.

Moreover, information for service identification (Service_id) is included in the NIT, and this service identification information indicates a service list. The service list is a list indicating a category (if there are a plurality of categories, the respective categories) of a program broadcasted, for example, by the received transport stream (TS) of a channel, and a selection number for selecting the program (including the representative program).

On the other hand, provisions of the terrestrial digital broadcasting include the following (1) to (5). When a terrestrial digital broadcasting receiver is first installed, the service list is acquired in conformity with the provisions.

(1) First a user sets an audience residential area.

(2) By a scanning start instruction, 13 ch to 62 ch are searched to acquire a service list.

(3) In the network information table (NIT), a remote controller key identifier (remote_control_key_id) is described, and remote controller key numbers (1) to (12) desired by a broadcasting company are assigned to each transport stream (TS) (accordingly, the representative service for each TS is attached to a remote controller key).

(4) When the same TS is detected, C/N or BER is checked to select a dominant carrier.

(5). Receiver processing in a case where the same remote controller key number is detected is separately provided.

In the setting of the audience residential area of the above (1), it is assumed that a user sets the area on the GUI.

As described above, when the terrestrial digital broadcasting receiver is first installed, the user first sets the audience residential area. The audience residential area is first forcibly designated in this manner.

Next, the TS is received by a frequency scanning operation of the receiver, and it is judged whether or not audience residential area information (received information) in service identification information in the TS matches the first set audience residential area information (stored information). When the received audience residential area information matches the stored audience residential area information, it means that the terrestrial digital broadcasting receiver receives radio waves (TS) from the broadcasting company (broadcasting station) in the first installed area (in a broadcasting area). When the received audience residential area information does not match the stored audience residential area information, it means that the terrestrial digital broadcasting receiver receives the radio waves (TS) from the broadcasting company (broadcasting station) outside the area (outside the broadcasting area).

[Patent Document 1] Jpn. Pat. Appln. KOKAI Publication No. 11-215445

[Patent Document 2] Jpn. Pat. Appln. KOKAI Publication No. 2001-298674

However, when the reality of broadcasting business is considered, the radio waves from the station of the broadcasting company of each broadcasting area are not necessarily separated exactly for each broadcasting area. Therefore, (A) in the terrestrial digital broadcasting receiver installed in the vicinity of a boundary of the broadcasting area, there may be case that radio wave conditions in its own area are not necessarily advantageous. Moreover, in consideration of the future of the broadcasting business, (B) although the same program is broadcasted among a plurality of broadcasting areas (e.g., adjacent broadcasting areas), a channel number sometimes differs because the broadcasting company differs. Furthermore, it is also considered that the terrestrial digital broadcasting receiver is installed under the conditions in which both broadcasting company channels can be received. In this case, when the audience residential area is first set in the digital broadcasting receiver, it may fail to set the channel from the adjacent area having good receiving conditions. (C) Furthermore, in view of the increase in broadcasting companies that is likely to occur, the user may need to reset the receiver, thus causing an inconvenience to the user.

### BRIEF SUMMARY OF THE INVENTION

An aspect of the present invention is to provide a digital receiving device and a digital broadcasting receiving method in which a service list can be acquired from an area having an advantageous receiving state of a receiver, and receiving environments can be set. Moreover, there are provided a digital receiving device and a digital broadcasting receiving method in which a service list is easily acquired without imposing any burden to a user, even when an installation area of the receiver is changed or the receiver is moved. Furthermore, there are provided a digital receiving device and a digital broadcasting receiving method in which even a state of a change in content of a service list or the like is easily seen by a user and reliability of a product is enhanced.

According to embodiments of the present invention, there is provided a device comprising: a digital tuner receiving a digital broadcasting signal and specifying a plurality of channels receivable by a scanning operation; a separator separating network information table information including company information from a transport stream of the plurality of channels; a storage storing service identification information identified for each residential area, the service identification information included in the network information table information; a change check section checking whether or not new received service identification information has been changed by comparing this information with the service identification information previously stored in the storage; and a display displaying changed contents associated with information service, when the new received service identification information is changed as a result of the check.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a basic constitution of a digital broadcasting receiver according to the present invention;

FIG. 2 is an explanatory view showing a hierarchical structure of a network information table (NIT);

FIG. 3 is an explanatory view showing a data arrangement of service identification included in the NIT;

FIG. 4 is an explanatory view showing a meaning of area identification in the service identification of FIG. 3;

FIG. 5 is an explanatory view showing the meaning of the area identification in the service identification of FIG. 3 in more detail;

FIG. 6 is an explanatory view showing the meaning of a prefecture bi-flag in the service identification of FIG. 3;

FIG. 7 is an explanatory view showing the meaning of a service type in the service identification of FIG. 3;

FIG. 8 is an explanatory view showing the meaning of company identification in the service identification of FIG. 3;

FIG. 9 is an explanatory view showing the meaning of service number in the service identification of FIG. 3;

FIG. 10 is a flowchart showing a basic operation of a receiver according to the present invention;

FIG. 11 is a flowchart showing an operation of a reception confirming step of FIG. 10;

FIGS. 12A and 12B are diagrams showing an example of a display screen obtained during operation of the receiver according to the present invention;

FIG. 13 is a diagram showing another example of the display screen obtained during the operation of the receiver according to the present invention;

FIGS. 14A and 14B are diagrams showing a characteristic example of the display screen obtained during the operation of the receiver according to the present invention;

FIGS. 15A and 15B are diagrams showing another characteristic example of the display screen obtained during the operation of the receiver according to the present invention;

FIG. 16 is an appearance diagram of a remote controller for operating the receiver according to the present invention;

FIG. 17 is a flowchart showing another operation of the receiver according to the present invention;

FIG. 18 is a diagram showing another example of the display screen obtained during the operation of the receiver according to the present invention;

FIG. 19 is a diagram showing appearance of a television receiver to which the present invention is applied;

FIG. 20 is a diagram showing the appearance of a system including a set top box to which the present invention is applied; and

FIG. 21 is a diagram showing a constitution example of a basic block in the set top box (STB) of FIG. 20.

### DETAILED DESCRIPTION OF THE INVENTION

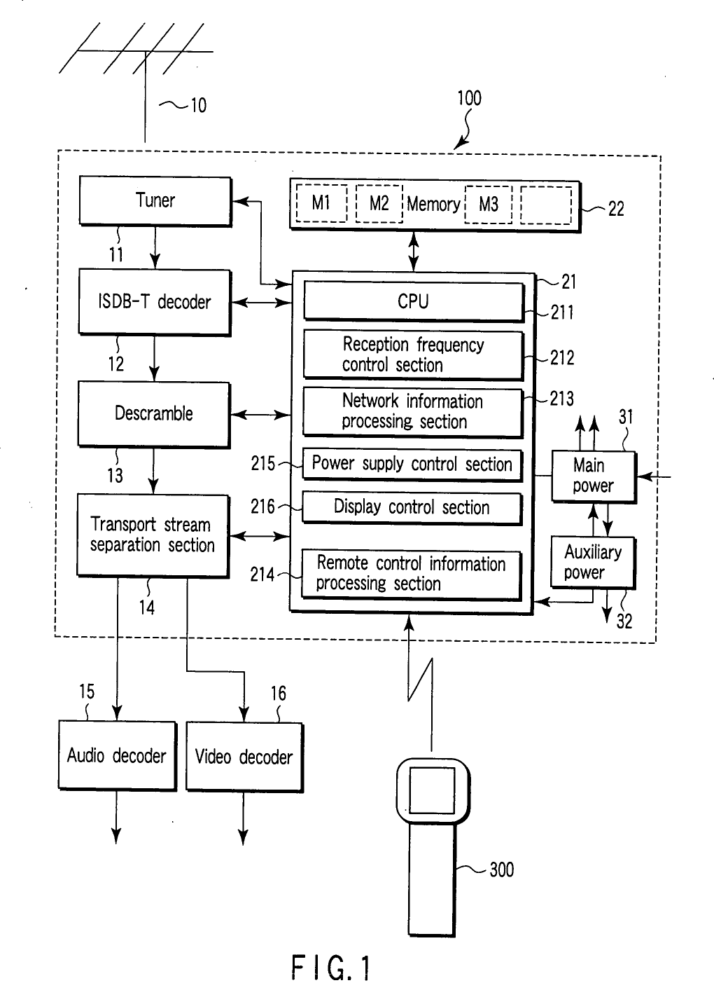

An embodiment of the present invention will be described hereinafter with reference to the drawings. FIG. 1 is a diagram showing a constitution of a main part of the present invention.

A digital broadcasting receiver 100 is connected to a UHF antenna 10 via a cable. Radio waves received by the UHF antenna 10 are guided to a tuner 11. A channel selection operation of the tuner 11 is controlled by a system control section 21.

An intermediate frequency signal obtained by the channel selection operation of the tuner 11 is input into an integrated services digital broadcasting-terrestrial (ISDB-T) decoder 12, and decoded into a stream signal. The stream signal is descrambled by a descrambler 13, and converted to an original transport stream. The transport stream is input into a transport stream separation section 14.

The transport stream separation section 14 separates packets which are, respectively, including video information, audio information, digital service information or the like from a packet row. The transport stream separation section 14 supplies an audio packet of a service program designated by the user to an audio decoder 15, and supplies a video packet to a video decoder 16 by a program selection signal from the system control section 21. Furthermore, packets of service information or control information are input into the system control section 21.

The system control section 21 includes a central processing unit (CPU) 211, and further includes a reception frequency control section 212, network information processing section 213, remote controller information processing section 214, power control section 215, display control section 216 and the like. The system control section 21 is connected to a work memory 22. The memory 22 includes a plurality of storage sections M1, M2, . . . , and data such as a service list and remote controller key number described later is stored in each region.

Reference numeral 31 denotes a main power, and 32 denotes an auxiliary power. The auxiliary power 32 turns on, for example, the remote controller information processing section 214, although the main power is turned off. Therefore, when a remote controller 300 outputs an operation signal for turning on the power, the remote controller information processing section 214 operates to turn on the main power 31. Accordingly, the digital broadcasting receiver 100 is brought into an on-state.

[Description of Operation at Receiver Installation Time] Next, an operation at a time when the digital broadcasting receiver is purchased and first installed by the user will be described. In the digital broadcasting receiver, initial scanning is first executed. Initial scanning is an operation for searching for a broadcasting company (broadcasting station) which sends receivable radio waves. The reception frequency is realized by controlling the tuner 11 by the reception frequency control section 212.

When the radio waves of the broadcasting station are caught, the network information table (NIT) included in the transport stream sent from the broadcasting station is acquired. The NIT is taken into the network information processing section 213 in the system control section 21 from the transport stream separation section 14 and processed.

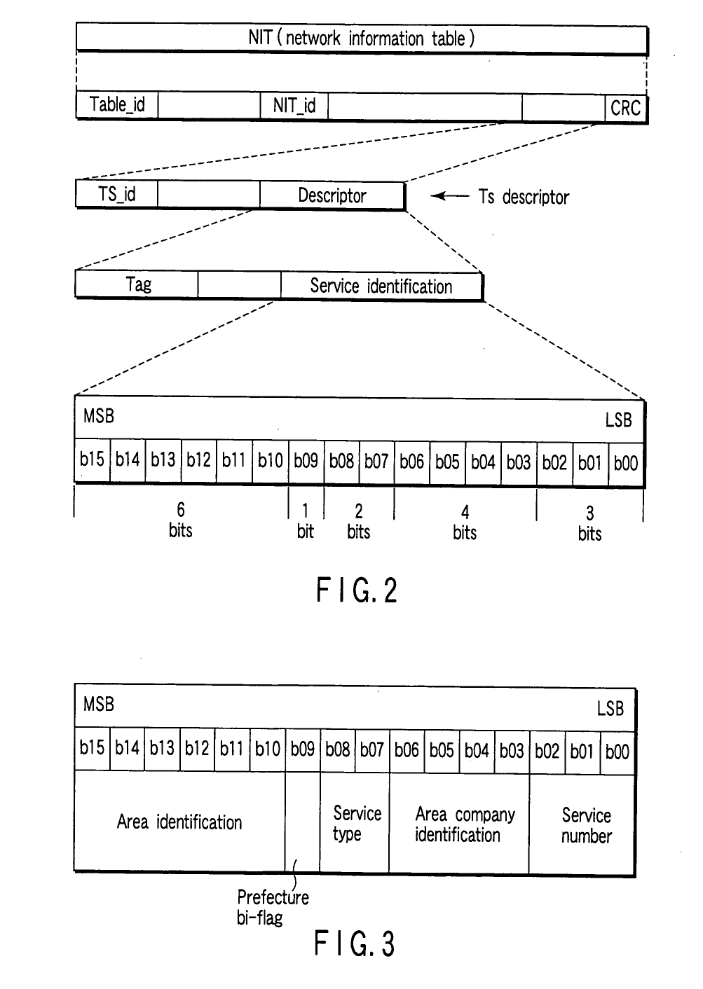

FIG. 2 schematically shows a hierarchical structure of the NIT, and shows the meaning of representative data. The control information included in the packet separated by the transport stream separation section 14 is analyzed by the network information processing section 213. As a result of the analysis, the NIT is sent and stored into the memory 22. The NIT includes a transport stream descriptor in addition to a table identifier (Table_id) and a network information table identifier (NIT_id). The transport stream descriptor includes a transport stream identifier (TS_id) and a descriptor. The descriptor includes a descriptor tag, and service identification (Service_id) information.

The present invention has characteristics of handling the service identification information. The service identification information includes units of six bits, one bit, two bits, four bits, three bits toward LSB from MSB, and each unit is given a meaning. That is, as shown in FIG. 3, the information includes the units of six bits (area identification), one bit (prefecture bi-flag), two bits (service type), four bits (area company identification), three bits (service number).

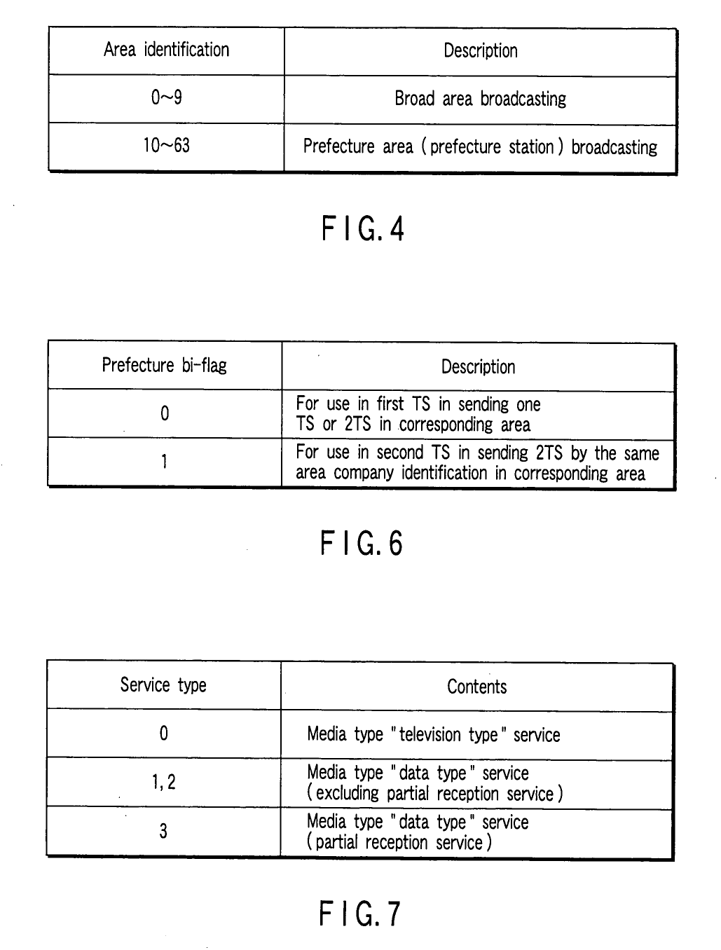

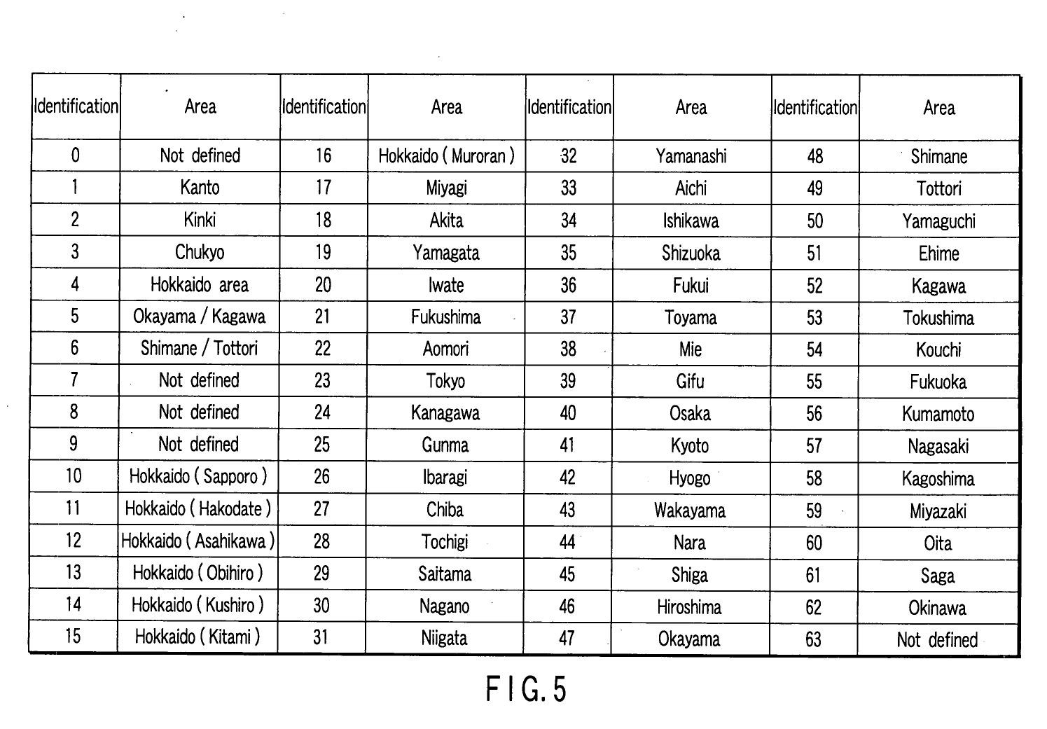

As shown in FIG. 4, when six bits (area identification) are 0 to 9, this refers to a broad broadcasting area, and the broadcasting area is determined by each value. Moreover, when they are 10 to 63, these refer to a prefecture area (prefecture station), and the prefecture including a broadcasting station is assigned to each value. FIG. 5 shows that values of 0 to 9 are assigned to broad areas in Japan, and that 10 to 63 are assigned to prefectures.

One bit (prefecture bi-flag) is determined as shown in FIG. 6. When the flag is “0”, the flag is attached in a case where the same broadcasting company sends a TS in the same area. When two TSs are sent, the flag is attached to the first TS. When the flag is “1”, and when the same broadcasting company sends two TSs in the same area, the flag is attached to the second TS.

Two bits (service type) are determined as shown in FIG. 7. That is, “0” indicates that a media type is a “television type” service. “1” or “2” indicates that the media type is a “data type” service (excluding partial reception service), and “3” means that the media type is a “data type” service (partial reception service).

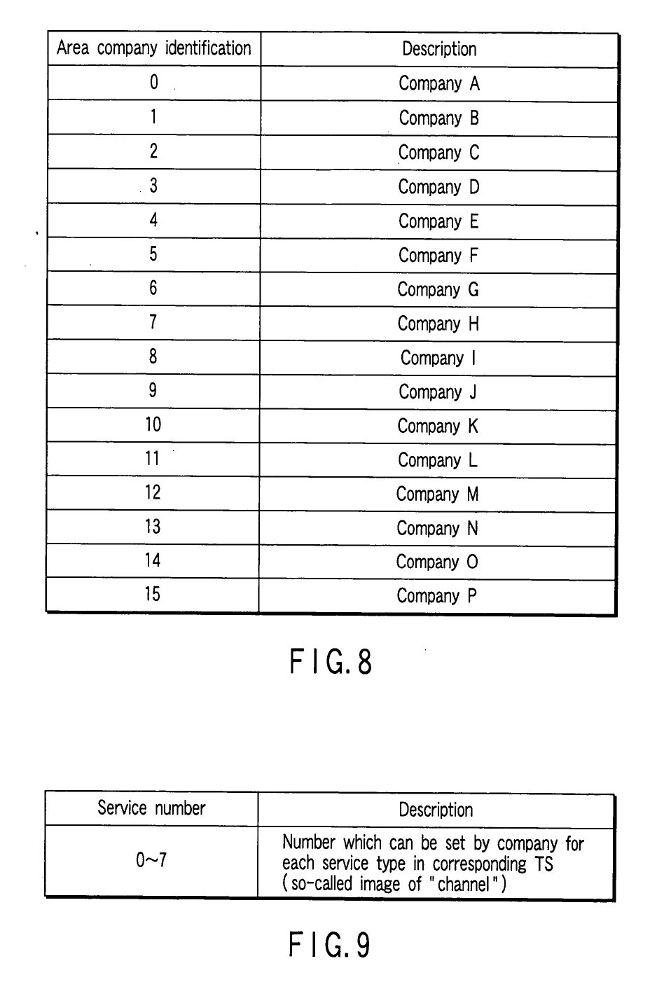

Four bits (area company identification) are determined as shown in FIG. 8. Values of 0 to 15 are set, and Companies A to P can be set to the respective values. The values of 0 to 15 may also be associated with remote controller key numbers as such.

Three bits (service number) are determined as shown in FIG. 9. That is, there are values of 0 to 7 (000, 001, 010, 011, . . . ), and they are usable as numbers which can be set by the company for each service type of the TS (categories such as news program, sports program, drama, and entertainment news program).

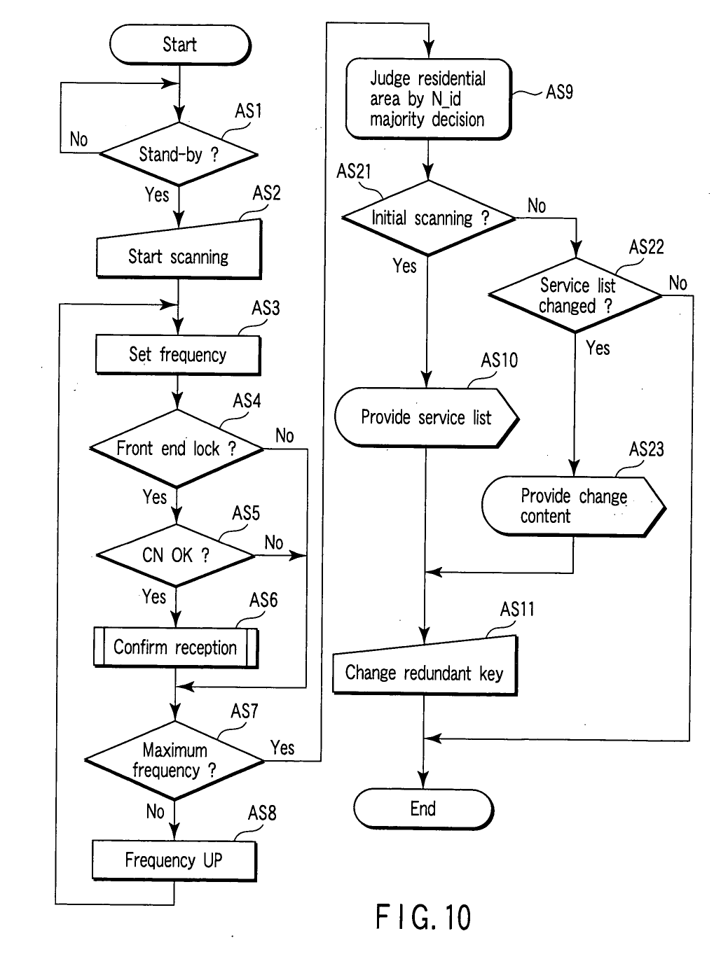

FIG. 10 shows that the receiver operates under the control of the system control section 21. At this time, the CPU 211 associates the reception frequency control section 212, network information processing section 213, power control section 215, and remote controller information processing section 214 with one another to control them. The receiver acquires the NIT and provides a service list. It is now assumed that the receiver is on standby (step AS1). It is also assumed that initial scanning is started by a user or is automatically start-up (step AS2).

The reception frequency control section 212 operates, reception frequency of the tuner 11 is set (e.g., physical channel 13) (step AS3), and it is judged whether or not a front end lock state is achieved (step AS4). This indicates that the channel exists in the front end lock state, and it is judged whether or not the CN (ratio of power to noise) is satisfactory (step AS5). When the CN is satisfactory, a reception confirmation process (step AS6) is carried out.

In the reception confirmation process, the NIT is acquired from the transport stream, and it is judged whether or not the NIT is already acquired. Moreover, transport stream ID is confirmed from the NIT. In the initial scanning, after the above confirmation, the above-described service list is acquired/added. The service list is stored in a storage area disposed in the memory 22.

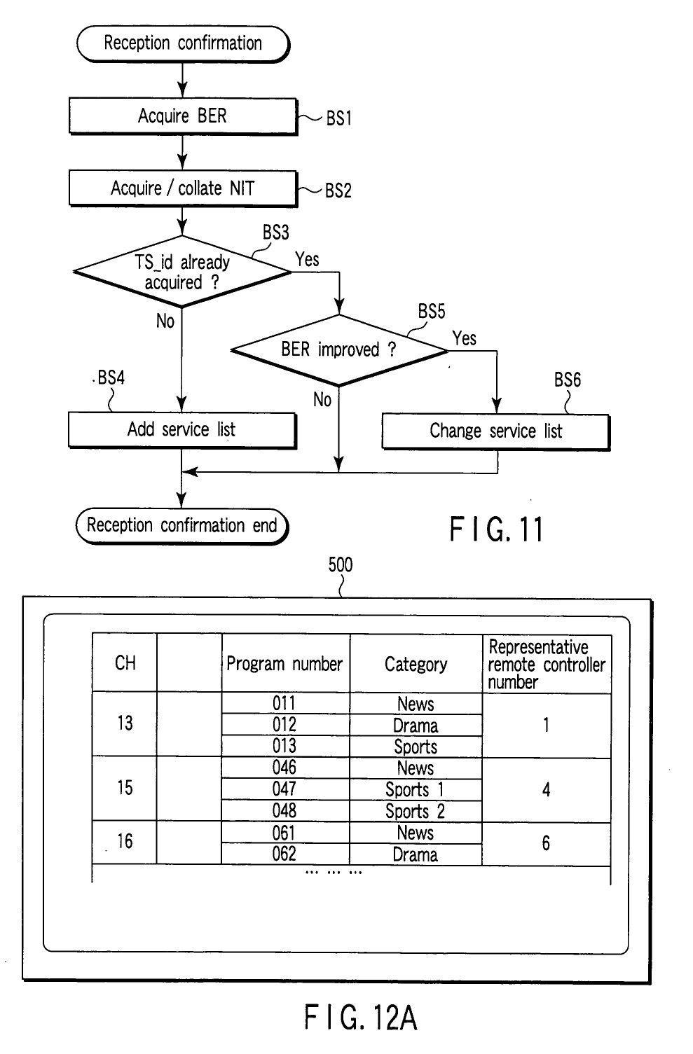

In FIG. 11, the reception confirmation operation of the step AS6 of FIG. 10 is shown in a flowchart in more detail. A bit error rate (BER) is acquired (step BS1), and next the NIT is acquired (step BS2). TS_id in the NIT is extracted (step BS3), and it is judged whether or not the NIT of the same transport stream is already acquired. Now, when the received NIT is not acquired yet, the service list is extracted, and added to the table of the memory 22 (step BS4). When it becomes clear in the step BS3 that the same information of the NIT has already been acquired, it is checked whether or not the BER has been improved in the reception operation. A bit error ratio changes in accordance with CN. When the BER is improved, the service list is newly decoded, and the service list is therefore changed (step BS6).

When the process of the transport stream in a reception channel ends as described above, the process returns to FIG. 10 (step AS7→AS8), and the frequency is varied. The reception frequency is successively varied in this manner, and NITs of 13 to 63 channels are processed. When it becomes clear that the frequency is maximum, the step shifts to step AS9.

The present invention is characterized in that the step AS9 exists. In the step AS9, network identification information is collected from each network information (corresponding to the transport stream) stored in the memory 22. Here, network identification information (N_id) may also be included in an independent form as shown in FIG. 2. It is considered that N_id is associated with a plurality of Service_ids. N_id may be calculated in consideration of area identification according to the following equation: N_id=0x7FF0-0x0010×area identification+area company identification-0x0400×prefecture bi-flag.

The information may be calculated from the above equation and stored in the memory 22. In terrestrial digital broadcasting, the fact that N_id has the same content as that of TS_id may also be used.

The content of N_id is determined by the area. Therefore, when N_id of each network information table (each reception channel) becomes clear, an area where the broadcasting company possessing each channel exists is known from the content of each N_id. Here, when majority is decided using the information of a plurality of existence areas, a residential area where the digital broadcasting receiver is installed can be specified. That is, as a result of majority decision, an existence area where most broadcasting companies exist becomes clear, and this area is judged to be the residential area of the digital broadcasting receiver.

Additionally, in this method, the residential area is not previously allocated, and reception conditions are judged to determine the residential area. Therefore, even when the digital broadcasting receiver is physically installed in residential area X1, the residential area X2 is set in the receiver, because of the reception conditions of radio waves from the adjacent residential area X2 are satisfactory, and the broadcasting radio waves from many broadcasting companies of the residential area X2 are received.

Here, it is judged whether or not the above-described frequency varying operation is performed for the initial scanning (step AS21). With the initial scanning, the service list stored in the memory 22 is provided (step AS10).

It is to be noted that, as described later, “initial scanning” indicates that all tables in the NIT memory are cleared once and the service list is constructed from an initial state. On the other hand, “rescanning” indicates that the scanning is started without deleting the service list in the NIT memory and that a portion including a change is updated or added.

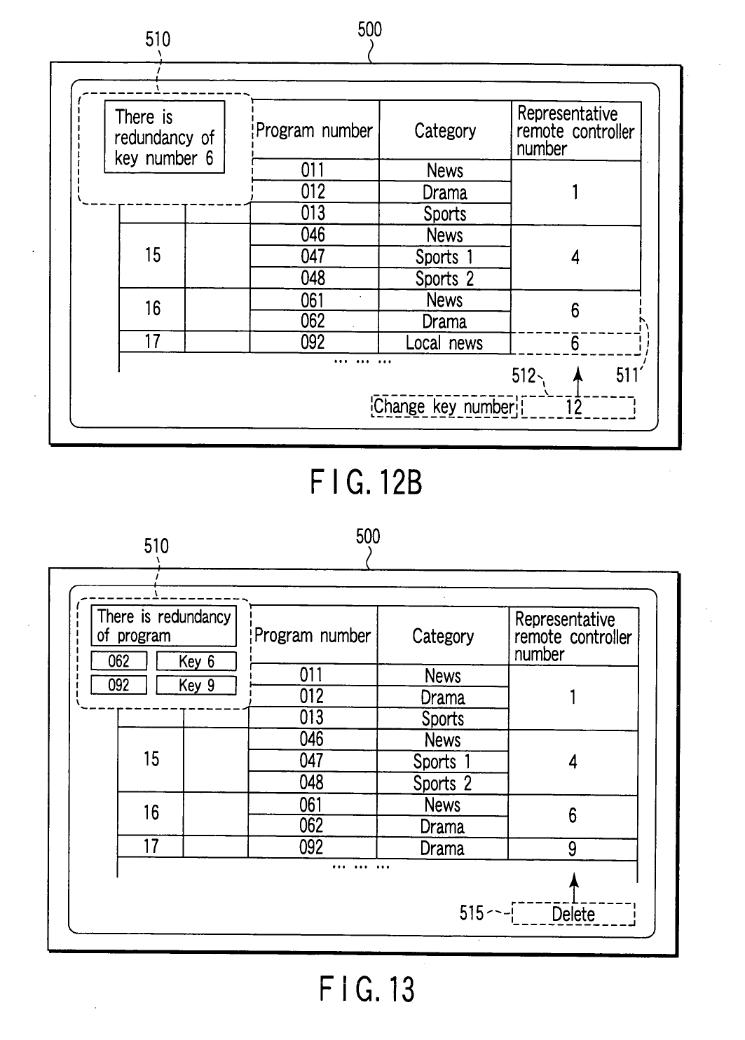

For example, as shown in FIGS. 12A and 12B, the provision of the service list indicates that a program number is indicated with respect to a reception channel number. Moreover, incidentally, the category (news, drama, sports, etc.) of the program content corresponding to each program number (011, 012, 013, etc.) may also be displayed. Furthermore, a representative remote controller key number (1, 4, 6, etc.) assigned to each channel (transport stream) may also be displayed. The display operates under the control of the display control section 216 of FIG. 1.

The remote controller key number (1, 4, 6, etc.) is described as a remote controller key identifier in the NIT. For example, the transport descriptor of FIG. 2 indicates service identification, but the remote controller key identification may also be described in the transport descriptor including another tag.

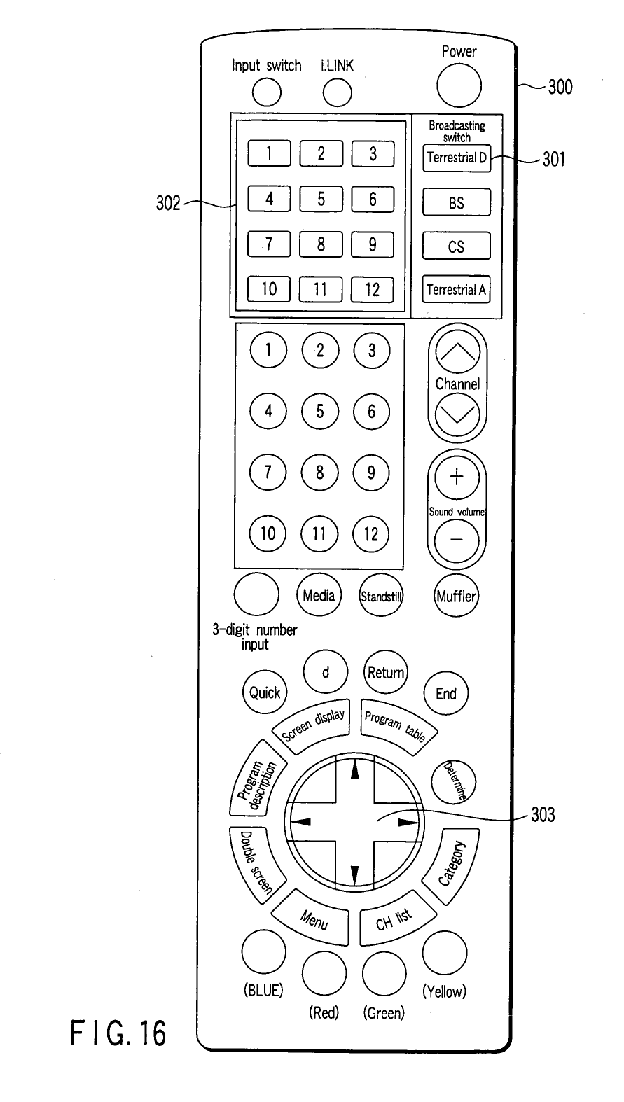

Each broadcasting company assigns independent remote controller key numbers (1) to (12) to each transport stream (TS). The remote controller key number is associated with a representative service for each TS. For example, with the channel 13 of FIG. 2, when a remote controller number 1 is operated, news having a program number 011 is selected. When a program number other than 011 is selected, an upward or downward arrow key of the remote controller is operated from the state of the program number 011, and a program having a program number 012 or 013 can be selected. When a remote controller key number 4 is operated, the program having a program number 046 of 15 channels is selected. The remote controller 300 is shown in FIG. 16.

FIG. 16 shows an example of the appearance of the remote controller 300. When a terrestrial digital broadcasting receiver selection button 301 is operated, ground waves can be received. When the remote controller key number of a key arrangement section 302 is operated, a desired channel (shown in FIGS. 12A and 12B) can be selected, and a reception state of a representative program of the channel is obtained. When the selected program is to be changed in the same reception channel, the program can be changed by operation of an up or down key of an operation section 303.

Returning to FIGS. 12A and 12B, a receiving device of the present invention is capable of receiving the transport stream from broadcasting companies of a plurality of areas over the residential area to construct the service list. Therefore, a program content sometimes differs with first and second TSs to which the same remote controller key number is assigned. Even with the first and second TSs to which different remote controller key numbers are assigned, the program content is sometimes the same.

Then, in this system, the program content differs with the first and second TSs to which the same remote controller key number is assigned. In this case, as shown in FIG. 12B, it can be displayed that there is redundancy of the channel number. In a display configuration, a redundant remote controller key number is displayed, for example, in a left upper portion 510 of the screen. Moreover, a redundant number portion 511 on the service list is flashed, or displayed in alternating colors. To change either key number, a number entry portion 512 to be newly set is displayed. The user inputs a new key number (12 in the figure) in this portion 512 through the remote controller. Moreover, when the portion 512 is superposed upon a desired position with an arrow key of the remote controller, and an enter key is operated, the key number is replaced.

Moreover, even with the first and second TSs to which different remote controller key numbers are assigned, the program content is sometimes the same. In this case, as shown in FIG. 13, redundant program numbers and key numbers are displayed. In this case, a delete cursor is displayed, for example, in a left lower portion 515. The user moves this delete cursor to a table position to be deleted, using the remote controller. Then, when the enter key (execute key) is operated, the number can be deleted from the table. Accordingly, a reception operation does not respond to the deleted key number.

To judge that the content is the same even with the first and second TSs to which different remote controller key numbers are assigned, for example, it can be judged from company identification information. For example, when the same company possesses the broadcasting station, and sets different remote controller key numbers in areas A and B, and even when area identification information is different, area company identification information is the same. Therefore, when it is checked whether or not the same company identification information exists on the table of the service list, it can be judged whether or not streams including the same program content exist.

As described above, in the system of the present invention, when the initial scanning is performed, and even when the residential area is not first specified, the service list of the channel having satisfactory reception conditions can be constructed regardless of the residential area. Even when the service list is constructed without specifying the residential area in this manner, inconvenience or data conflict does not occur. When the data is redundant as described above, a function of performing treatment in such a manner that no operational inconsistency occurs is added.

It is to be noted that the program number of each channel can be calculated by the following equation. Program number=200×service type+10×remote controller key number+service number+1 For example, when the service type is television type “0”, the remote controller key number is “6”, and service number is “0”, the program number is “061”. When the service type is the television type “0”, the remote controller key number is “1”, and the service number is “1”, the program number is “012”.

Returning to FIG. 10, the receiving device of the present invention will be described. After determining the residential area by majority decision, it is judged whether or not there is a change place in the acquired service list. Moreover, when the service list is changed, the changed content is displayed so that the user sees the content. This function is a characteristic function of the present invention. This is especially useful for a device in which a channel having good receiving conditions is registered especially without first specifying the residential area, as in the present invention.

When it becomes clear in step AS21 of FIG. 10 that the initial scanning is not performed, it is checked whether or not there is a change of the service list (step AS22).

That is, it is assumed that service identification information stored already in the memory 22 and including at least network identification information is first identification information and that new identification information corresponding to the first identification information and newly acquired by the equal reception frequency is second identification information. Here, the first identification information is compared with the second identification information to judge whether or not the new second identification information has been changed. When it is judged whether or not the information is changed, all is not necessarily changed, and it is judged whether or not even a portion is changed. When the second identification information is changed as a result of judgment, the change content is displayed so that the content is seen (step AS23).

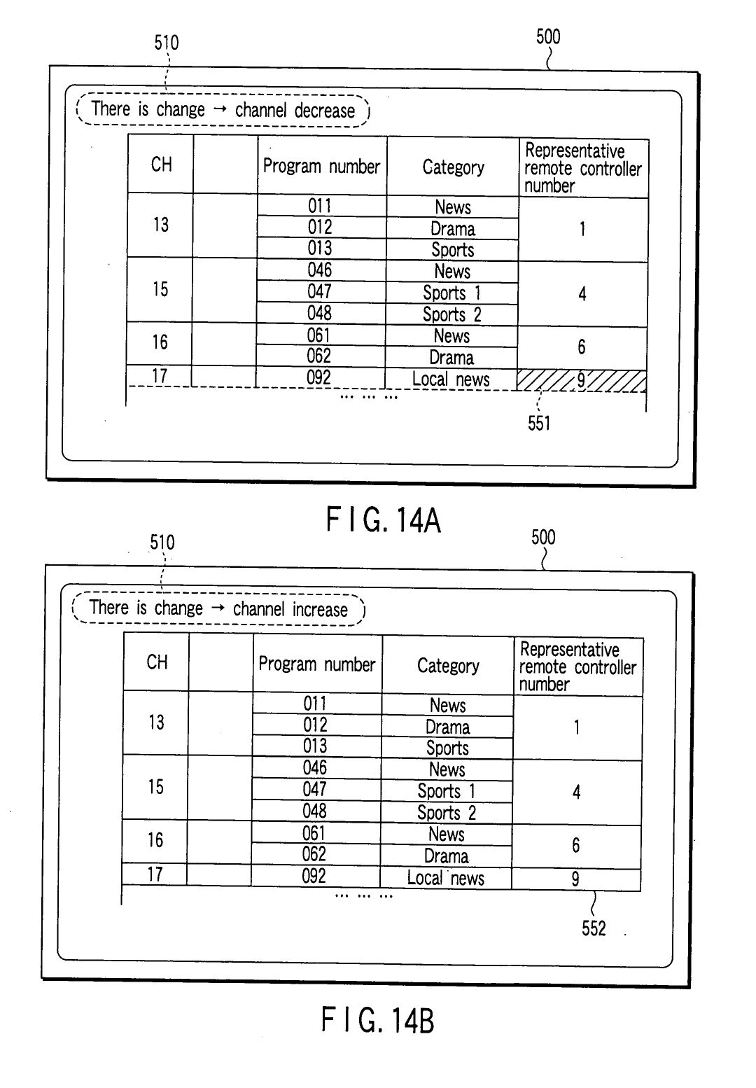

Some display examples will be described hereinafter. FIG. 14A shows that the service list is displayed in a screen 500 and a message 510 indicating that there is a change of the service list is obtained on the left upper part of the screen. In this case, an example indicating “decrease of channels” is shown. In a row 551 of a channel “17” which has heretofore been displayed in the service list, for example, a color of the row is varied, or the row is displayed by a dotted line. A flashing display may also be used. In brief, the message may also be displayed in a conspicuous form for the user. This display state is obtained after there is a change and only when the rescanning is performed first.

FIG. 14B shows an example in which the service list is displayed in the screen 500, and the message 510 shows “increase of the channels”. In a row 552 of the channel “17” which has not heretofore been displayed in the service list, for example, the color is varied, or the row is displayed by a flashing display. Also in this case, this display state is obtained after there is a change and only when the rescanning is performed first.

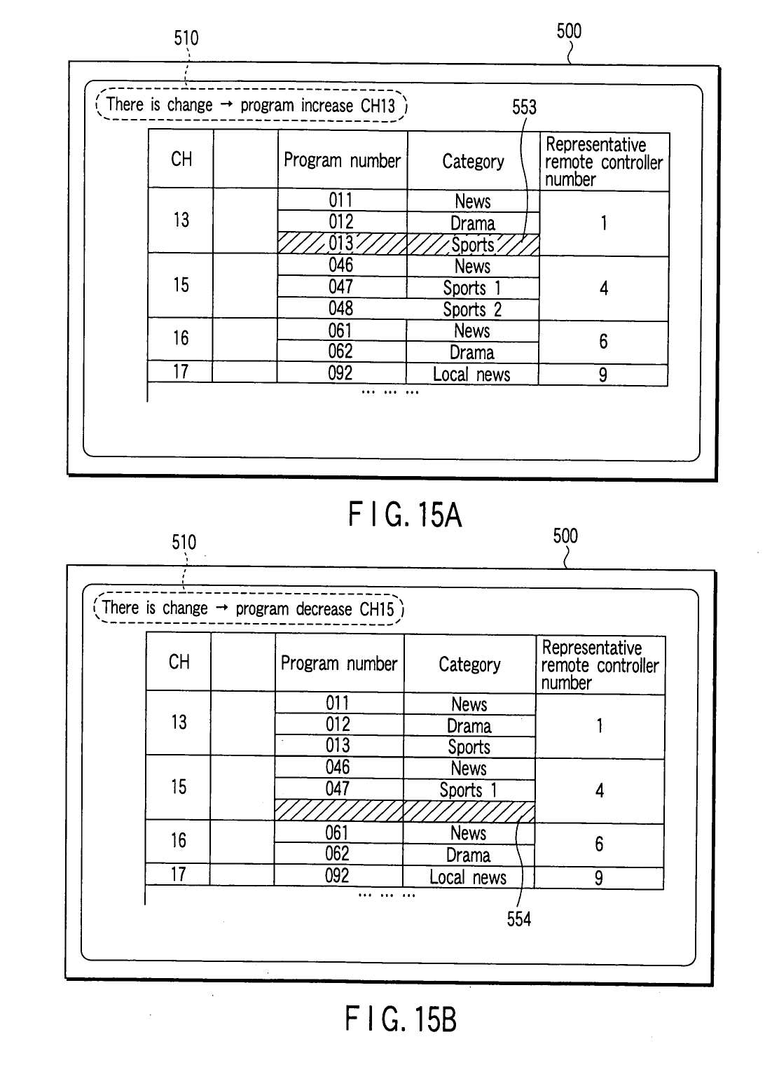

FIG. 15A shows an example in which the service list is displayed in the screen 500 and the message 510 displays that “programs increase in channel 13”. In a row 553 of programs which have not heretofore been displayed in the service list, for example, the color of the row is varied, or the row is displayed by flashing the display. Even in this case, this display state is obtained after there is a change and only when the rescanning is performed first.

FIG. 15B shows an example in which the service list is displayed in the screen 500, and the message 510 shows “programs of channel 15 decrease”. In a row 554 of programs which have not heretofore been displayed in the service list, for example, the color is varied, or the row is displayed by flashing. Also in this case, this display state is obtained after there is a change and only when the rescanning is performed first.

Moreover, the device of the present invention includes means for storing the change content to construct history data, when second service identification information is changed in a stage of step AS23. Moreover, the history data includes displaying means. To display the history data, for example, the remote controller 300 is operated, the menu is displayed, and a service list change history may be selected from the displayed menu. Then, for example, only the changed places shown in FIGS. 14, 15 are read from the memory 22 and displayed in a display section. The history data includes date information so that the change is seen if any.

Moreover, it has been described with reference to FIG. 10 that the change content is always provided when there is a change in the service list during the rescanning. However, the present invention is not limited to the above-described embodiment. The change is once stored as history data if any. Thereafter, only when there is a read instruction (display instruction from the menu state) from the user via the remote controller, changed content display means functions, and the changed content (FIGS. 14A, 14B, 15A and 15B) may also be displayed.

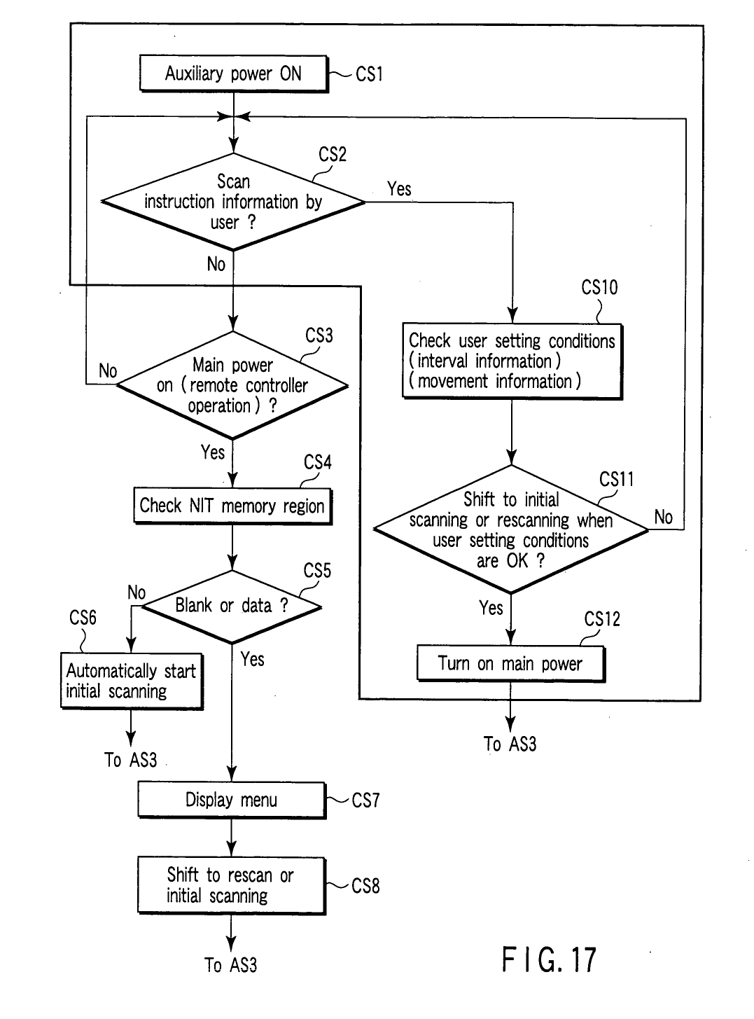

FIG. 17 shows another embodiment of the present invention. In the flowchart shown in FIG. 10, there is no distinction between automatic start and start by manual operation in a step AS1 in a standby state and scanning start step AS2. FIG. 17 shows an operation flow until the scanning is started.

At this time, an auxiliary power is turned on. Accordingly, the CPU checks a work memory (not shown) to judge whether or not scanning instruction information by the user is stored (steps CS1, CS2). That is, in the present system, start condition information for rescanning or initial scanning can be stored in the memory beforehand. When the scanning instruction information exists, the process shifts to step CS10 to check user setting conditions. Examples of the user setting conditions include interval information (time information) for performing the rescanning, movement detection information, and power-off information.

The interval information instructs the rescanning to be carried out, for example, after elapse of 24 or 48 hours. The movement detection information is effective, for example, when the receiver is mounted on a car, boat, train or the like. In this case, the movement information is received from a navigator using GPS. The information instructs the rescanning to be executed when the location of the receiver changes, for example, by about 4 km to 10 km. The power-off information instructs the rescanning to be executed, when the power resets after turning off both the main and auxiliary powers. This information may also be used in a composite manner or individually in a singular manner.

By this function, the rescanning is automatically performed, even when the user moves, which reduces the burden on the user. Even when a new broadcasting station is installed in an adjacent area, an environment capable of automatically acquiring new broadcasting service can be automatically obtained.

Furthermore, when no scanning instruction information is set by the user (step CS2), it is checked whether or not each power has been turned on (step CS3). When the main power is turned on, the NIT memory region of the memory 22 is checked (step CS4). As a result, when the region is blank, the initial scanning operation is automatically started (step CS6). The subsequent operation has been described above with reference to FIG. 10.

When data exists in the NIT memory region in the step CS5, the process shifts to menu display (step CS7). Here, the user is allowed to select “rescanning” or “initial scanning” as desirable through the display. Here, “initial scanning” indicates that all the tables in the NIT memory are cleared once and the service list is constructed from the initial state. On the other hand, “rescanning” indicates that the scanning is started without deleting the service list in the NIT memory and that a portion including the change is updated or added. When the user selects either process, the process shifts to the rescanning or initial scanning process.

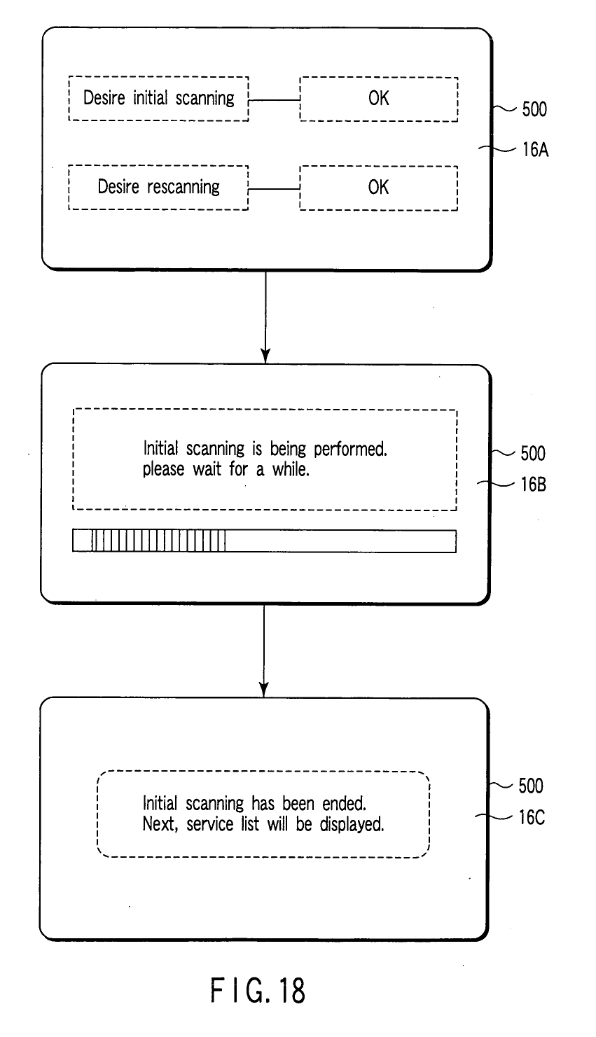

FIG. 18 shows an example of a configuration of a menu screen. In the step CS7, as shown in a screen 16A of FIG. 18, there is an inquiry as to whether “rescanning or “initial scanning” is desired. The user moves a cursor on the screen to select either one. When the scanning operation is started, a scanning state is displayed as shown in a screen 16B. When the scanning ends, a message is obtained as in a screen 16C.

As described above, in the receiver of the present invention, the tuner 11 varies the reception frequency to receive each channel of a digital broadcasting signal at a standby time. The decoder 12, descrambler 13, transport stream separation section 14, and system control section 21 separate network information table (NIT) information including company information for handing the channel from the transport stream of each channel obtained from the tuner. The memory (storage means) 22 is included in the separated NIT under the control of the system control section 21, and stores network identification (N_id) information which can be identified for each residential area.

Furthermore, the system control section 21 specifies the residential area to which most network identification (N_id) information belongs from a plurality of pieces of network identification (N_id) information stored in the memory 22 under the operation of the network information processing section 213, and judges that the residential area is an area where the receiver is installed.

Additionally, the memory 22 has a second storage region where the remote controller key number designated in the NIT by the company corresponding to the NIT is associated with the remote controller key number for use in operation and stored.

Moreover, the system control section 21 has a function of displaying in a display that the key numbers are redundant, when the remote controller key numbers designated in a plurality of NITs are the same with respect to a key number of the remote controller.

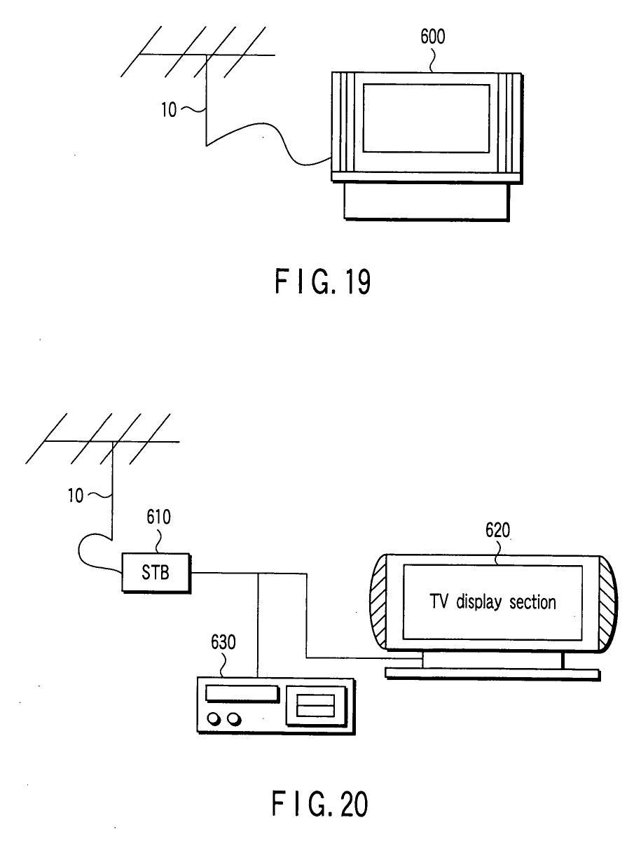

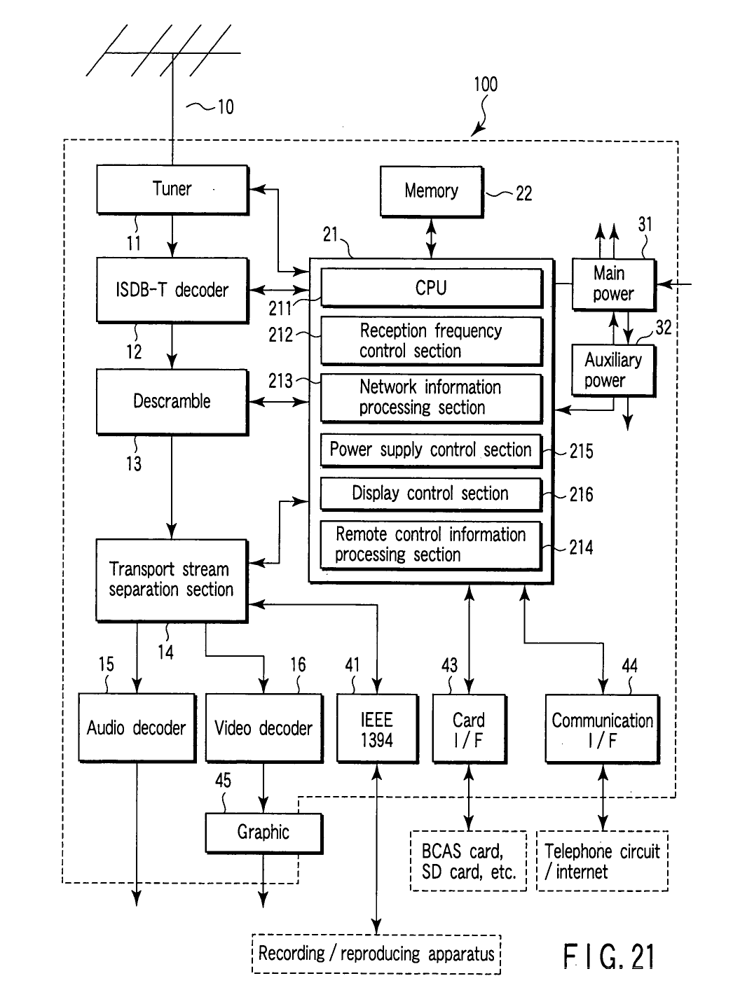

The block constitution shown in FIG. 1 is formed of basic blocks of the present invention, and the constitution of FIG. 1 may exist independently, or may be of a type built in a television receiver 600 shown in FIG. 19. Furthermore, as shown in FIG. 20, the constitution may be of a type built into a set top box (STB) 610. The STB 610 may be connected to a television display section 620 via an indoor cable, and may be connected to a recording/reproducing apparatus 630 such as DVD and VTR. The STB to which a main part of the present invention is applied is constituted, for example, as shown in FIG. 20. The same parts as those of FIG. 1 are denoted with the same reference numerals. In this example, an IEEE1394 processing section 41 for transmitting the transport stream along the provision of IEEE1394 is further added. The system control section 21 is further connected to a card interface 43 and a communication interface 44. The card interface 43 is used, for example, to input necessary key information for deciphering a scrambled signal from a BCAS card. Alternatively, the card interface 43 may also be used in order to input contents such as image data and audio data from the SD card. The communication interface 44 is used for connecting the receiver 100 to the Internet or a telephone line. An output of the video decoder 16 is derived via a graphic processing section 45, and supplied to the TV display section.

Technical characteristics of the present invention will be summarized hereinafter.

As shown in 11 of FIG. 1 and the steps AS2 to AS7 of FIG. 10, the digital tuner 11 changes the reception frequency of the received broadcasting, receives the digital broadcasting signal by the scanning operation, and specifies a plurality of receivable channels. Next, as shown in 14, 21 of FIG. 1, step AS6 of FIG. 10, and step BS2 of FIG. 11, the separation means separates the network information table information including the company information concerning each channel from the transport stream of a plurality of channels specified by the digital tuner.

In the storage means, as shown in 21, 22 of FIG. 1 and steps BS4, BS6 of FIG. 11, identification information is stored which is included in the network information table information separated for each channel and which can be identified for each residential area. Moreover, as shown in the steps AS22, AS23 of FIG. 10, the change check means constructed by the network information processing section 213 of FIG. 1 assumes that the service identification information already stored in the storage means is first service identification information and the information newly acquired by the change of the reception frequency in accordance with the first identification information is the second service identification information. The first service identification information is compared with the second service identification information to check whether or not the new second service identification information has been checked. Moreover, means for displaying the change content, constructed by the display control section 216, displays the change content, when the second service identification information is changed as a result of the check.

Moreover, the present invention includes the area specifying means (step AS9 of FIG. 10) which judges the residential area to which much service identification information belongs from the service identification information stored in the storage means (memory 22) to specify that the judged residential area is the existing area.

As seen from the display mode of FIGS. 12A to 15B, the means for displaying the change content associates the channel number, the program number corresponding to the channel number, and the remote controller key number corresponding to the channel number with one another to display the numbers. Furthermore, as shown in the display mode of FIGS. 14A and 14B, the means for displaying the change content associates a plurality of channel numbers, program numbers corresponding to the channel numbers, and a plurality of remote controller key numbers corresponding to the channel numbers with one another to display the numbers, and further identifies a display portion of the changed channel number from another display portion. Furthermore, as shown in the display mode of FIGS. 15A and 15B, the means for displaying the change content identifies the display portion of the changed program number from another display portion. To identify the changed portion from another displayed portion, flashing, or the color different from a peripheral color is set and displayed. Further the present invention includes means for storing the change content to construct history data, when the second service identification information is changed, and means for displaying the history data. Here, the change content display means may also display a changed place, when the history data is read by the operation. Furthermore, since date information is attached to the history data, a time when there has been a change is easily seen.

According to the present invention, when the receiver is installed, the service list can be acquired from an area where the reception state of the receiver is advantageous, without the user sets the audience residential area. Even when the installation area of the receiver is changed, or the receiver is moved, the service list can be acquired without imposing any burden onto the user. Moreover, when there are changes such as addition, deletion, and correction with respect to the content of the service list, the state is display, the reliability of the product can be obtained, and misunderstandings such as trouble are not caused.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A digital broadcasting receiver comprising:
a digital tuner receiving a digital broadcasting signal and specifying a plurality of channels receivable by a scanning operation;
a separator separating network information table information including company information from a transport stream of the plurality of channels;
a storage storing service identification information identified for each residential area, the service identification information included in the network information table information;
a change check section checking whether or not new received service identification information has been changed by comparing this information with the service identification information previously stored in the storage; and
a display displaying changed contents associated with information service, when the new received service identification information is changed as a result of the check.

2. The digital receiving device according to claim 1, further comprising:
area specifying section judging and specifying a residential area as the existing area of the receiver, by judging much identification information stored in the storage.

3. The digital broadcasting receiver according to claim 1, wherein the display displays the changed content associates a channel number, a program number corresponding to the channel number, and a remote controller key number corresponding to the channel number.

4. The digital broadcasting receiver according to claim 1, wherein the display displays the changed state associates a plurality of channel numbers, program numbers corresponding to the channel numbers, and a plurality of remote controller key numbers corresponding to the channel numbers, and
identifies a display portion of the changed channel number from another display portion.

5. The digital broadcasting receiver according to claim 4, wherein the changed portion is displayed by flashing or a color different from a peripheral color.

6. The digital broadcasting receiver according to claim 1, wherein the display displays the changed state associates a plurality of channel numbers, program numbers corresponding to the channel numbers, and a plurality of remote controller key numbers corresponding to the channel numbers, and
identifies a display portion of the changed program number from another display portion.

7. The digital broadcasting receiver according to claim 6, wherein the changed portion is displayed by flashing or a color different from a peripheral color so that the changed portion is identified from the other display portion.

8. The digital broadcasting receiver according to claim 1, further comprising:
a storage storing changed content, when the new service identification information is changed, to construct history data; and
a display displaying the history data.

9. The digital broadcasting receiver according to claim 8, wherein the display displays a changed place, when the history data is read out.

10. The digital broadcasting receiver according to claim 8, wherein the history data includes date information.

11. A digital broadcasting receiver comprising:
a digital tuner receiving a digital broadcasting signal and specifying a plurality of channels receivable by a scanning operation;
a separator separating network information table information including company information from a transport stream of the plurality of channels;
a storage storing service identification information identified for each residential area, the service identification information included in the network information table information;
a change check section checking whether or not new received service identification information has been changed by comparing this information with the service identification information previously stored in the storage; and
a display displaying changed contents associated with information service, when the new received service identification information is changed as a result of the check, and having a display area displaying redundant key numbers.

12. The digital broadcasting receiver according to claim 11, wherein said display further has a display area displaying a new changing key number input portion.

13. The digital broadcasting receiver according to claim 11, wherein said display further has a display area displaying redundant and corresponding program numbers to key numbers.

14. The digital broadcasting receiver according to claim 13, wherein said display further displays a deleting cursor.

15. A digital broadcasting receiving method comprising the steps of:
receiving a digital broadcasting signal by a scanning operation of a digital tuner and specifying a plurality of channels receivable;
separating network information table information including company information from a transport stream of the plurality of channels by a separator;
storing service identification information identified for each residential area a storage, the service identification information included in the network information table information;
checking, a change check section, whether or not new received service identification information has been changed by comparing this information with the service identification information previously stored in the storage; and
displaying changed contents associated with information service, by a display, when the new received service identification information is changed as a result of the check.

16. The digital broadcasting receiving method according to claim 15, the displaying step further including the step of:
displaying redundant key numbers, and redundant corresponding program numbers to the key numbers.

17. The digital broadcasting receiving method according to claim 16, the displaying step further including the step of:
displaying an area for correcting or deleting a selected key number or a selected program number.
